(19) United States
(12) Patent Application Publication
(10) Pub. No.: US 2006/0289267 A1
(43) Pub. Date: Dec. 28, 2006

(54) Hydraulic pressure control valve

(75) Inventor: Joji Ito, Fukuroi-shi (JP)

Correspondence Address: CROWELL & MORING LLP;INTELLECTUAL PROPERTY GROUP, P.O. BOX 14300, WASHINGTON, DC, 20044-4300, US

(73) Assignee: NSK-Warner K.K., Shinagawa-ku (JP)

(21) Appl. No.: 11/472,459

(22) Filed: Jun. 22, 2006

(30) Foreign Application Priority Data
Jun. 23, 2005 (JP) 2005-182794

(51) Int. Cl. F16D 25/00

(52) U.S. Cl. 192/85 R

(57) ABSTRACT

A hydraulic pressure control valve for an oil chamber in a hydraulic multiplate clutch assembly is disclosed. The hydraulic pressure control valve is to be mounted on a pressing piston in the hydraulic multiplate clutch assembly. The hydraulic pressure control valve includes a valve plate composed of a leaf spring for controlling a leak hole formed through the pressing piston; and a single-piece weight staked on the valve plate such that valve-opening force for the leaf spring is increased under centrifugal force.

### FIELD OF THE INVENTION

This invention relates to a hydraulic pressure control valve suitable for use in a hydraulic multiplate clutch by mounting it on a piston in the hydraulic multiplate clutch.

### DESCRIPTION OF THE BACKGROUND

FIG. 1 illustrates in cross section the outline of the construction of a hydraulic multiplate clutch equipped with a hydraulic pressure control valve. The hydraulic multiplate clutch 10 comprises a driving shaft 20, a clutch case 21, a driven shaft 30, a piston 40, and so on.

Designated at numeral 22 is a spline groove, in which separator plates 23 are fitted. Numeral 32 indicates another spline groove formed on a hub 31 which is arranged on the side of the driven shaft 30, and friction plates 24 are fitted in the spline groove 32. Numeral 25 indicates friction linings bonded on both sides of the friction plates 24. The piston 40 is provided with a leak hole 43 for hydraulic pressure, and a hydraulic pressure control valve 50 for controlling the leak hole 43 is mounted by a rivet 45 on a surface of the piston 40, said surface being on the side of an oil chamber 60.

To engage the clutch, pressure oil is fed from an oilway 61 into the oil chamber 60. The hydraulic pressure control valve 50 is then pressed rightward as viewed in the drawing so that the leak hole 43 is closed. As a consequence, the piston 40 is pressed rightward as viewed in the drawing, and by a pressing portion 41 of the piston 40, the separator plates 23 and friction plates 24 are pressed against a stopper ring 26 to bring the clutch into engagement. To disengage the clutch, pressure fluid is drained from the oil chamber 60. The piston 40 is then allowed to return leftward by a return spring 44 so that the clutch is disengaged. Any oil, which still remains in the oil chamber 60 at this time, is discharged through the leak hole 43. During the engagement of the clutch, a valve plate 51 of the hydraulic pressure control valve 50 keeps the leak hole 43 closed under the hydraulic pressure in the oil chamber 60.

Upon disengaging the clutch, centrifugal force is applied to the oil still remaining in the oil chamber 60, and therefore, the centrifugal force acts as force that closes the valve plate 51 of the hydraulic pressure control valve 50. If the spring force of the valve plate 51 is set strong enough to overcome the centrifugal force such that the valve can be opened, the hydraulic pressure control valve 50 cannot close the leak hole 43 until the pressure within the oil chamber 60 rises to a sufficiently high level upon engagement of the clutch. This causes a reduction in hydraulic pressure in the hydraulic pressure system. However, the use of a hydraulic pump of higher capacity with a view to avoiding such a reduction in hydraulic pressure leads to a reduction in overall efficiency, and moreover, a great deal of pressure oil (in other words, working oil) is quickly fed into the oil chamber, thereby developing a potential problem that the pressure may suddenly rise to produce a large engagement shock.

With a view to eliminating the above-mentioned inconvenience, it has hence been contemplated to provide the valve plate 51 with a weight (see, for example, JP-A-54-103940). If valve-opening force to be applied to a weight 52 under centrifugal force and valve-opening force to be applied to the oil remaining in the oil chamber 60 under the centrifugal force are set to become substantially equal to each other, drainage of pressure oil from the oil chamber 60 allows the oil pressure control valve 50 to open to permits a release of any remaining oil through the leak hole 43 even if the spring force of the valve plate 51 itself is small. Designated at numeral 42 in the drawing is a recessed portion formed inside the pressing portion 41 to accommodate the weight 52.

FIG. 9 onwards show the construction of a conventional hydraulic pressure control valve. FIG. 9 is a plan view of the valve plate 51, and illustrates a stake hole 53 for staking a weight and a rivet hole 54 for mounting the valve plate 51 on the piston. The weight 52 in the conventional hydraulic pressure control valve is formed of two members, that is, a first weight and a second weight. FIG. 10 depicts a relation between the valve plate and the first and second weights, and shows the first weight 55 and the second weight 56 arranged on opposite sides of the valve plate 51, respectively, as seen at an X-X cross section of FIG. 9. The first weight 55 is configured to have a flange portion 57 and a cylindrical portion 58, while the second weight 56 is centrally provided with a through-hole 59.

To stake the weight 52 on the valve plate 51, the cylindrical portion 58 of the first weight 55 is firstly inserted into the stake hole 53 of the valve plate 51, the cylindrical portion 58 is then caused to extend through the through-hole 59 of the second weight 56, the flange portion 57 of the first weight 55 and the second weight 56 are thereafter brought into close contact with the opposite sides of the valve plate 51, respectively, and the cylindrical portion 58 is finally pressed down, in other words, staked. As a result, the first weight 55 and second weight 56 have been joined together into the weight 52 to make up the hydraulic pressure control valve 50 (see FIG. 11). FIG. 12 shows on an enlarged scale the hydraulic pressure control valve 50 mounted on the piston 40 by the rivet 45.

As the weight in the conventional hydraulic pressure control valve are constructed by staking two weights from the opposite sides of the valve plate, extra cost is needed to manufacture the two weights separately. There are further problems in that upon assembling the first weight and the second weight together, an error tends to occur in the direction of fitting of the second weight and the fitting is laborious.

### SUMMARY OF THE INVENTION

To resolve the above-described problems, the present invention provides, in one aspect thereof, a hydraulic pressure control valve for an oil chamber in a hydraulic multiplate clutch assembly, said hydraulic pressure control valve being to be mounted on a pressing piston in the hydraulic multiplate clutch assembly, comprising:

a valve plate comprising a leaf spring for controlling a leak hole formed through the pressing piston; and

a single-piece weight staked on the valve plate such that valve-opening force for the leaf spring is increased under centrifugal force.

As the weight is in the form of a single-piece member, the present invention has achieved a reduction in manufacturing cost owing to a reduction in the number of parts, a reduction in assembling time and a simplification of a weight assembling mechanism. In addition, it is possible to avoid the error which tends to occur upon assembling the first and second weights together in the conventional art. The present invention has, therefore, brought about another advantage that the quality can be improved while easing workers' load.

### BRIEF DESCRIPTION OF THE DRAWINGS

FIG. 1 is a fragmentary cross-sectional view showing the basic construction of a hydraulic multiplate clutch.

FIG. 2 is a plan view of a valve plate for use in a hydraulic pressure control valve according to a first embodiment of the present invention.

FIG. 3 illustrates the valve plate as viewed at a III-III cross section of FIG. 2 and a weight for use in the hydraulic pressure control valve according to the first embodiment of the present invention, in which the valve plate and the weight are placed side by side.

FIG. 4 is a cross-sectional view of the hydraulic pressure control valve according to the first embodiment of the present invention.

FIG. 5 is a plan view of a valve plate for use in a hydraulic pressure control valve according to a second embodiment of the present invention.

FIG. 6 is a cross-sectional view of a weight for use in the hydraulic pressure control valve according to the second embodiment of the present invention.

FIG. 7 is a cross-sectional view of the hydraulic pressure control valve according to the second embodiment of the present invention.

FIG. 8 is a cross-sectional view of a weight as a modification of the weight for use in the hydraulic pressure control valve according to the second embodiment of the present invention.

FIG. 9 is a plan view of a valve plate for use in a conventional hydraulic pressure control valve.

FIG. 10 illustrates the valve plate as viewed at a X-X cross section of FIG. 9 and a first and second weight for use in the conventional hydraulic pressure control valve, in which the valve plate and the weight are placed side by side.

FIG. 11 is a cross-sectional view of the conventional hydraulic pressure control valve.

FIG. 12 is a cross-sectional view of the conventional hydraulic pressure control valve as mounted on a piston.

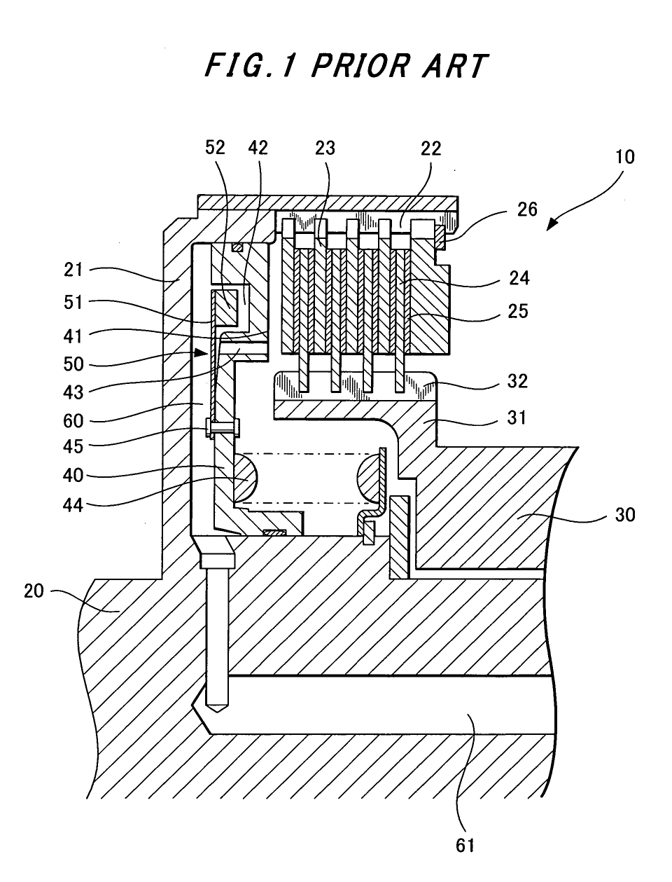

### DETAILED DESCRIPTION OF THE INVENTION AND PREFERRED EMBODIMENTS

Preferably, the valve plate can comprise a leaf spring in the form of a straight planar plate, and the single-piece weight can have a symmetrical shape with respect to a centerline relative to a direction of a width of the valve plate.

For example, the valve plate can be provided with a stake hole formed therethrough. The single-piece weight can comprise a cylindrical portion and a flange portion extending outwardly from an end part of the cylindrical portion. The cylindrical portion can extend through the stake hole and can be staked at an opposite end part thereof to hold the valve plate between the flange portion and the staked opposite end part.

As an alternative, the valve plate can be provided with a stake hole formed therethrough and an insertion slot extending from the stake hole to a side edge of the valve plate. The single-piece weight can comprise a block, preferably a cylindrical block, with slits formed on opposite ends of the block, respectively, to define an H-shaped cross-section. The single-piece weight is inserted into the stake hole through the insertion slot while being guided at the slits thereof by corresponding edge portions of the insertion slot. The single-piece weight is staked on the valve plate. Preferably, the block can be provided with a further slit formed on a leading end of the block as viewed in the direction of insertion of the single-piece weight through the insertion slot.

As a modification of the above-described single-piece weight, the single-piece weight can comprises a disc-shaped portion, a head portion extending from the disc-shaped portion, and slits formed on opposite ends of the single-piece weight at intermediate positions between the disc-shaped portion and the head portion. The single-piece weight is inserted into the stake hole through the insertion slot while being guided at the slits thereof by corresponding edge portions of the insertion slot. The head portion is staked to hold the valve plate between the disc-shaped portion and the staked head portion. Preferably, the single-piece weight can be provided with a further slit formed on a leading end of the single-piece weight as viewed in the direction of insertion of the single-piece weight through the insertion slot.

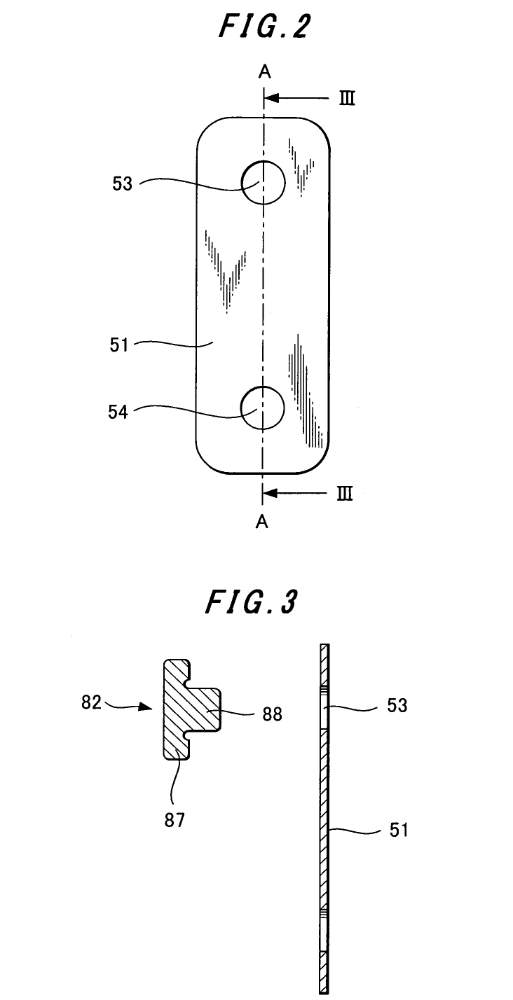

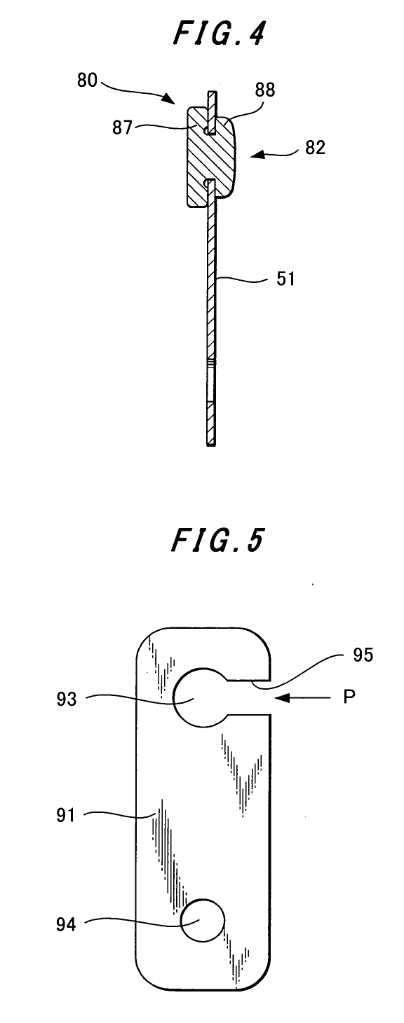

Referring first to FIGS. 2 through 4, the hydraulic pressure control valve according to the first embodiment of the present invention will be described. FIG. 2 shows a valve plate 51 in the hydraulic pressure control valve 80 according to the first embodiment, in which numeral 53 indicates a stake hole for staking a weight and numeral 54 designates a rivet hole for mounting the valve plate 51 on a piston by a rivet. FIG. 3 shows, side by side, a cross-sectional view of the valve plate 51 as viewed at a III-III cross section of FIG. 2 and the weight 82 in the hydraulic pressure control valve according to the first embodiment. FIG. 3 illustrates the valve plate 51 and the stake hole 53. The weight 82 is configured to have a flange portion 87 and a cylindrical portion 88. FIG. 4 depicts the hydraulic pressure control valve 80 according to the first embodiment.

Referring now to FIG. 3, the assembly procedure of the hydraulic pressure control valve 80 will be described. The stake hole 53 of the valve plate 51 is fitted on the cylindrical portion 88, and by a staking machine, the weight 82 is staked on the valve plate 51. As illustrated in FIG. 4, the flange portion 87 and the cylindrical portion 88 are staked together, from the opposite sides of the valve plate 51, with the valve plate 51 being interposed between them. As a consequence, the weight 82 is formed to make up the hydraulic pressure control valve 80. The valve plate 51 functions as a leaf spring, which is in the form of a straight planar plate and has resiliency by itself. The weight 82 is staked precisely on a centerline A-A relative to the direction of the width of the valve plate 51, and therefore, has a symmetrical shape with respect to the centerline.

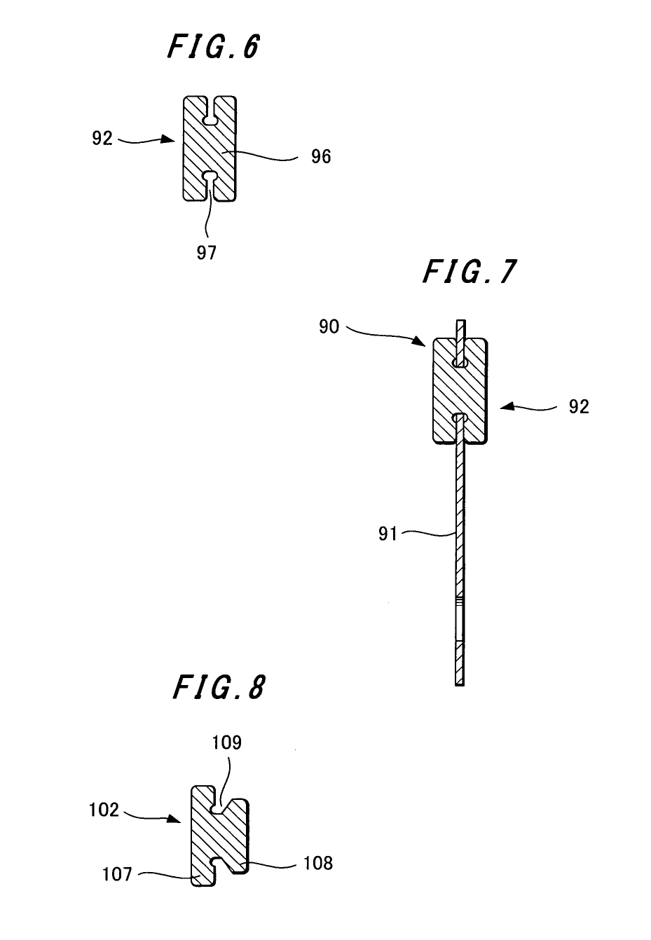

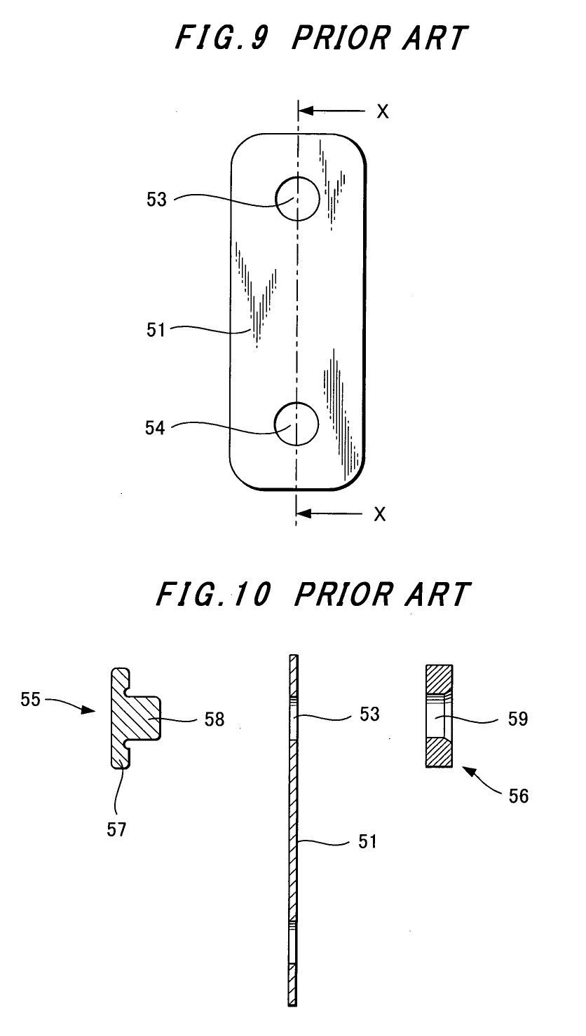

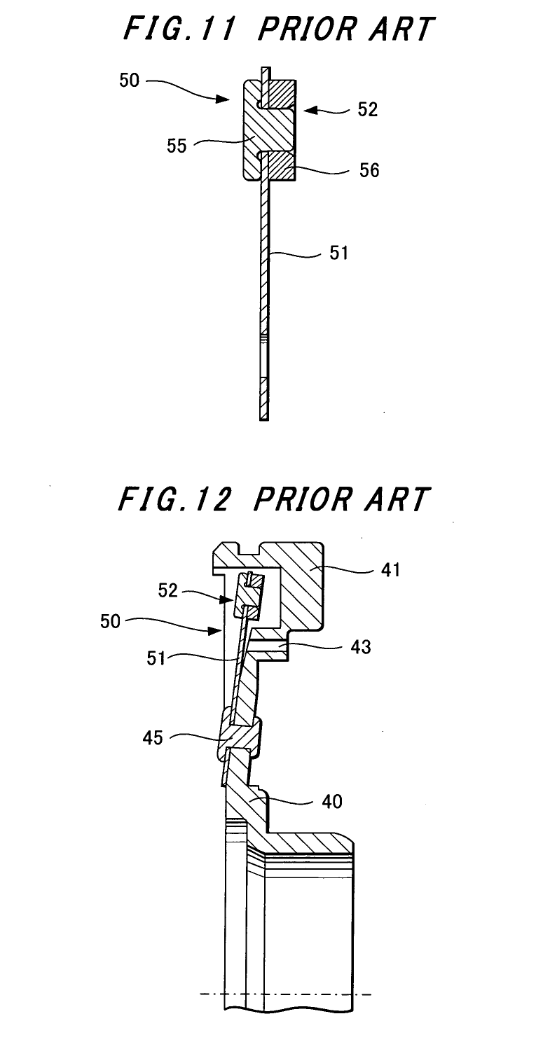

With reference to FIGS. 5 through 7, a description will next be made of the hydraulic pressure control valve according to the second embodiment of the present invention. FIG. 5 shows a valve plate 91 in the hydraulic pressure control valve according to the second embodiment. This valve plate 91 is provided with an insertion slot 95 formed extending from a stake hole 93 to a side edge of the valve plate 91. As depicted in FIG. 6, a weight 92 in the hydraulic pressure control valve 80 according to the second embodiment comprises a cylindrical block 96 with slits 97 formed on opposite ends of the cylindrical block 96, respectively, to define an H-shaped cross-section. Preferably, the cylindrical block 96 can be provided with a further slit formed on a leading end thereof as viewed in a direction of insertion of the weight 92 through the insertion hole 95. This further slit serves to facilitate the positioning of the weight 92 on a centerline relative to the direction of a width of the valve plate 91 when the weight 92 has been inserted leftward to the very end of the stake hole 93.

FIG. 7 is similar to FIG. 4, and depicts the hydraulic pressure control valve 90 according to the second embodiment. The hydraulic pressure control valve 90 can be assembled as will be described hereinafter. The weight 92 shown in FIG. 6 is inserted leftward, that is, in the direction arrow P (see FIG. 5) into the stake hole 93 through the insertion slot 95 while being guided at the slits 97 thereof by their corresponding edge portions of the insertion slot 95. As shown in FIG. 7, the weight 92 is staked on the valve plate 91 to hold weight 92 in place on the valve plate 91. In the above-described second embodiment of the present invention, the weight 92 comprises the cylindrical block 96. It is, however, to be noted that no limitation is imposed on the shape of the block. For example, the block may be in the form of a rectangular parallelepiped, cube or disc.

FIG. 8 shows the weight 102 as a modification of the weight 92 in the hydraulic pressure control valve 90 according to the second embodiment. The weight 102 comprises a disc-shaped portion 107, a head portion 108 extending from the disc-shaped portion 107, and slits 109 formed on opposite ends of the weight 102 at intermediate positions, specifically middle positions between the disc-shaped portion 107 and the head portion 108. Preferably, the weight 102 can be provided with a further slit formed on a leading end thereof as viewed in the direction of insertion of the weight 102 through the insertion slot 95. The further slit serves to facilitate the positioning of the inserted weight 92 on the centerline relative to the direction of the width of the valve plate 91 when the weight 102 has been inserted leftward to the very end of the stake hole 93.

The weight 102 can be assembled with the valve plate 91 (see FIG. 5) as will be described hereinafter. Referring back to FIG. 5, the weight 102 is inserted leftward, that is, in the direction arrow P into the stake hole 93 through the insertion slot 95 while being guided at the slits 109 thereof by their corresponding edge portions of the insertion slot 95. The head portion 108 is next staked to hold the valve plate 91 between the disc-shaped portion 107 and the thus-staked head portion 109. As a result, the weight 102 is held in place on the valve plate 91.

This application claims the priority of Japanese Patent Application 2005-182794 filed Jun. 23, 2005, which is incorporated herein by reference.

1. A hydraulic pressure control valve for an oil chamber in a hydraulic multiplate clutch assembly, said hydraulic pressure control valve being to be mounted on a pressing piston in said hydraulic multiplate clutch assembly, comprising:
a valve plate comprising a leaf spring for controlling a leak hole formed through said pressing piston; and
a single-piece weight staked on said valve plate such that valve-opening force for said leaf spring is increased under centrifugal force.

2. A hydraulic pressure control valve according to claim 1, wherein said valve plate comprises a leaf spring in a form of a straight planar plate; and said single-piece weight has a symmetrical shape with respect to a centerline relative to a direction of a width of said valve plate.

3. A hydraulic pressure control valve according to claim 2, wherein said valve plate is provided with a stake hole formed therethrough; said single-piece weight comprises a cylindrical portion and a flange portion extending outwardly from an end part of said cylindrical portion; and said cylindrical portion extends through said stake hole and is staked at an opposite end part thereof to hold said valve plate between said flange portion and said staked opposite end part.

4. A hydraulic pressure control valve according to claim 2, wherein said valve plate is provided with a stake hole formed therethrough and an insertion slot extending from said stake hole to a side edge of said valve plate; said single-piece weight comprises a block with slits formed on opposite ends of said block, respectively, to define an H-shaped cross-section; said single-piece weight has been inserted into said stake hole through said insertion slot while being guided at said slits thereof by corresponding edge portions of said insertion slot; and said single-piece weight is staked on said valve plate.

5. A hydraulic pressure control valve according to claim 4, wherein said block is cylindrical.

6. A hydraulic pressure control valve according to claim 4, wherein said block is provided with a further slit formed on a leading end of said block as viewed in a direction of insertion of said single-piece weight through said insertion slot.

7. A hydraulic pressure control valve according to claim 2, wherein said valve plate is provided with a stake hole formed therethrough and an insertion slot extending from said stake hole to a side edge of said valve plate, said single-piece weight comprises a disc-shaped portion, a head portion extending from said disc-shaped portion, and slits formed on opposite ends of said single-piece weight at intermediate positions between said disc-shaped portion and said head portion; said single-piece weight has been inserted into said stake hole through said insertion slot while being guided at said slits thereof by corresponding edge portions of said insertion slot; and said head portion is staked to hold said valve plate between said disc-shaped portion and said staked head portion.

8. A hydraulic pressure control valve according to claim 7, wherein said single-piece weight is provided with a further slit formed on a leading end of said single-piece weight as viewed in a direction of insertion of said single-piece weight through said insertion slot.
